(19) United States
(12) Patent Application Publication
(10) Pub. No.: US 2014/0028610 A1
(43) Pub. Date: Jan. 30, 2014

(54) CAPACITIVE TOUCH SYSTEM AND METHOD OF OPERATING A CAPACITIVE TOUCH SYSTEM

(71) Applicant: CHUNGHWA PICTURE TUBES, LTD., Taoyuan (TW)

(72) Inventors: Tzu-Hsuan Huang, Taipei City (TW); Chih-Yin Chiang, Nantou County (TW); Ju-Yi Hsieh, Taoyuan County (TW)

(73) Assignee: Chunghwa Picture Tubes, Ltd., Taoyuan (TW)

(21) Appl. No.: 13/633,889

(22) Filed: Oct. 3, 2012

(30) Foreign Application Priority Data
Jul. 24, 2012 (TW) 101126594

(51) Int. Cl. G06F 3/044

(52) U.S. Cl. 345/174

(57) ABSTRACT

A capacitive touch system includes a touch panel, a detection circuit, and a microprocessor. The touch panel includes a plurality of first axis lines of a first axis and a plurality of second axis lines of a second axis. The processor is used for controlling the detection circuit to transmit a first transmission signal to a first axis line and receive a plurality of first detection signals corresponding to the first transmission signal from the second axis lines. If a delay between a first detection signal of the plurality of first detection signals and the first transmission signal is greater than a first predetermined value, the processor controls the detection circuit to transmit a second transmission signal to a second axis line corresponding to the first detection signal, and receive a plurality of second detection signals corresponding to the second transmission signal from the plurality of first axis lines.

### BACKGROUND OF THE INVENTION

1. Field of the Invention

The present invention relates to a capacitive touch system and a method of operating a capacitive touch system, and particularly to a capacitive touch system and a method of operating a capacitive touch system that can utilize a detection circuit to switch a receiving signal line of the detection circuit and a transmitting signal line of the detection circuit according to a delay between a detection signal and a transmission signal.

2. Description of the Prior Art

Please refer to FIG. 1. FIG. 1 is a diagram illustrating a touch device 100 according the prior art. As shown in FIG. 1, the touch device 100 includes a touch panel 102, a first detection circuit 103, a second detection circuit 104, and a microprocessor 106. The touch panel 102 includes a plurality of X axis lines XS1-XSN of an X axis and a plurality of Y axis lines YS1-YSM of a Y axis, where each axis line of the plurality of X axis lines XS1-XSN and the plurality of Y axis lines YS1-YSM is coupled to a plurality of sensing units, and N and M are integers. For example, an X axis line XS1 is coupled to a plurality of sensing units 1022. Please refer to FIG. 2. FIG. 2 is a diagram illustrating the first detection circuit 103 and the second detection circuit 104 detecting a touch point P of the touch panel 102. As shown in FIG. 2, the first detection circuit 103 can transmit transmission signals to the plurality of X axis lines XS1-XSN in turn according to a predetermined timing, and the second detection circuit 104 can receive detection signals from the plurality of Y axis line YS1-YSM to make the microprocessor 106 detect a location of a touch point of the touch panel 102. For example, when the first detection circuit 103 transmits a transmission signal to an X axis line XS1 (meanwhile, the X axis line XS1 acts as a transmitter of the touch device 100), the second detection circuit 104 receives detection signals from the plurality of Y axis line YS1-YSM (meanwhile, the plurality of Y axis line YS1-YSM act as receivers of the touch device 100). Then, the microprocessor 106 can determine a location of a touch point P of the touch panel 102 according to the detection signals.

However, as shown in FIG. 1, because a parasitic capacitor between the transmitter (the X axis line XS1) and the receiver (e.g. the Y axis line YS1) has a very small capacitance, the detection signal received by the receiver (e.g. the Y axis line YS1) is much less than the transmission signal transmitted by the transmitter (the X axis line XS1). Thus, when a finger 108 touches the transmitter (that is, the location of the touch point P), interference caused by the finger 108 to the detection signal received by the receiver (e.g. the Y axis line YS1) may make the microprocessor 106 not determine the location of the touch point P of the touch panel 102 according to the detection signal received by the receiver (e.g. the Y axis line YS1).

### SUMMARY OF THE INVENTION

An embodiment provides a capacitive touch system. The capacitive touch system includes a touch panel, a detection circuit, and a microprocessor. The touch panel includes a plurality of first axis lines of a first axis and a plurality of second axis lines of a second axis. The detection circuit is coupled to the touch panel. The microprocessor is used for controlling the detection circuit to transmit a first transmission signal to a first axis line, and receiving a plurality of first detection signals corresponding to the first transmission signal from the plurality of second axis lines. If a delay between a first detection signal of the plurality of first detection signals and the first transmission signal is greater than a first predetermined value, the microprocessor controls the detection circuit to transmit a second transmission signal to a second axis line corresponding to the first detection signal, and receive a plurality of second detection signals corresponding to the second transmission signal from the plurality of first axis lines.

Another embodiment provides a method of operating a capacitive touch system. The capacitive touch system includes a touch panel, a detection circuit, and a microprocessor. The touch panel includes a plurality of first axis lines of a first axis and a plurality of second axis lines of a second axis. The method includes the microprocessor controlling the detection circuit to transmit a first transmission signal to a first axis line, and receiving a plurality of first detection signals corresponding to the first transmission signal from the plurality of second axis lines; the microprocessor controlling the detection circuit to transmit a second transmission signal to a second axis line corresponding to a first detection signal of the plurality of first detection signals, and receiving a plurality of second detection signals corresponding to the second transmission signal from the plurality of first axis lines if a delay between the first detection signal and the first transmission signal is greater than a first predetermined value; and the microprocessor calculating a location of at least one touch point of the touch panel according to the plurality of second detection signals.

The present invention provides a capacitive touch system and a method of operating a capacitive touch system. The capacitive touch system and the method first utilize a microprocessor to control a detection circuit to transmit a first transmission signal to a first axis line, and receive a plurality of first detection signals corresponding to the first transmission signal from a plurality of second axis lines. Then, when a delay between a first detection signal of the plurality of first detection signals and the first transmission signal is greater than a first predetermined value, the microprocessor controls the detection circuit to transmit a second transmission signal to a second axis line corresponding to the first detection signal. Then, the microprocessor controls the detection circuit to receive a plurality of second detection signals corresponding to the second transmission signal from a plurality of first axis lines. Thus, compared to the prior art, the present invention has advantages of quick scan and reducing interference of receiving signal lines of the detection circuit caused by an object which touches a touch panel .

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a touch device according the prior art.

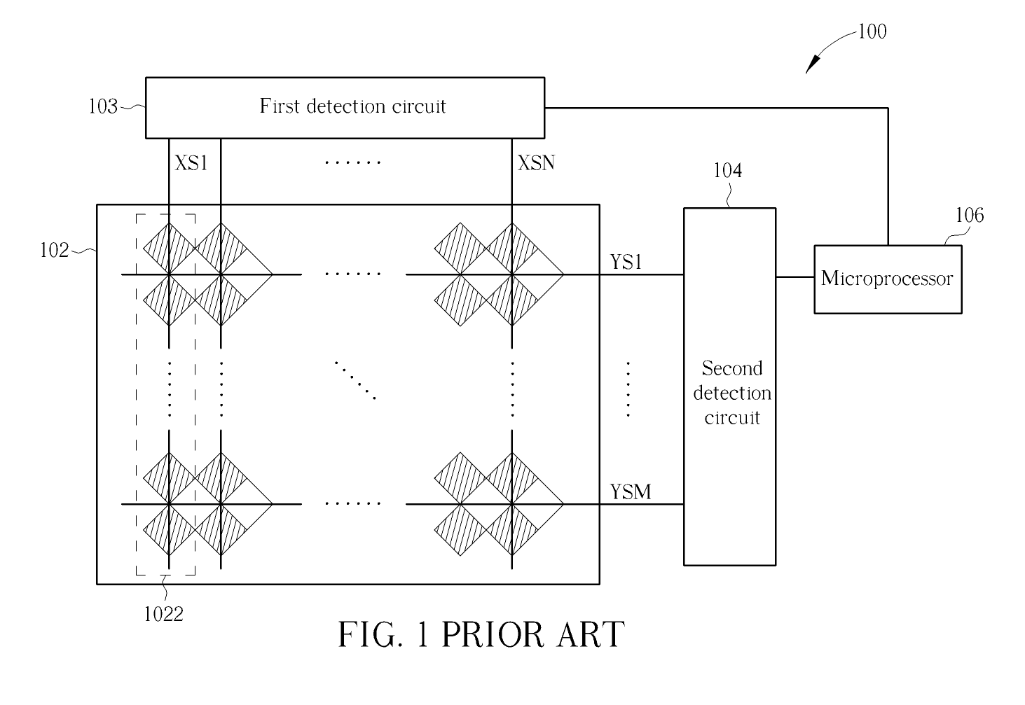

FIG. 2 is a diagram illustrating the first detection circuit and the second detection circuit detecting a touch point P of the touch panel.

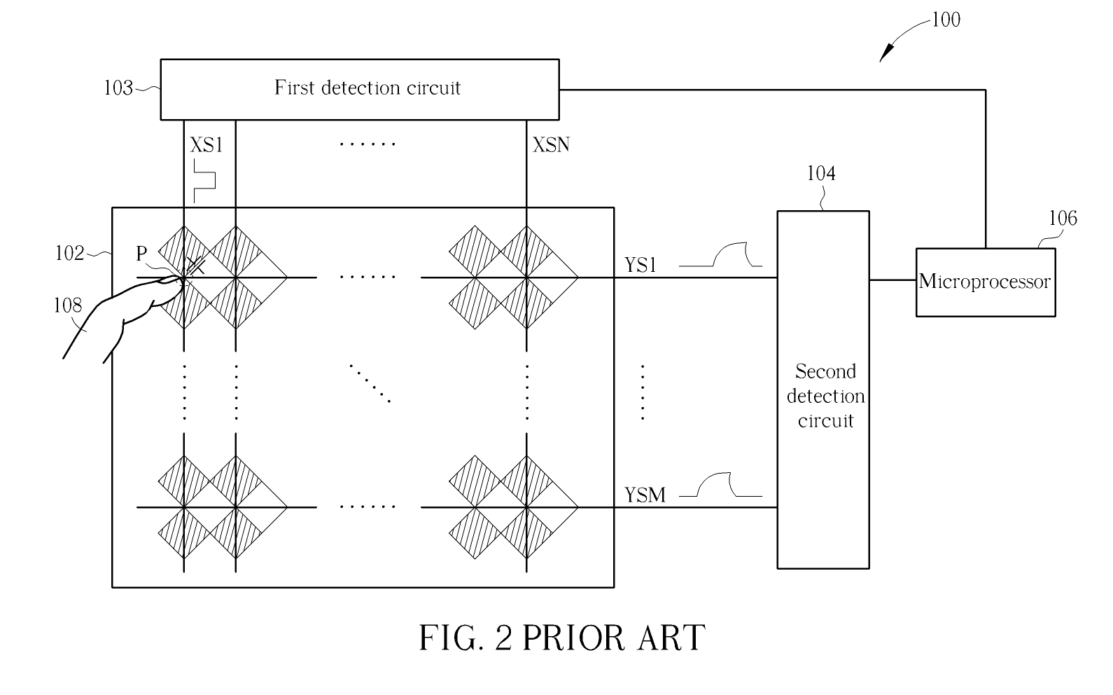

FIG. 3 is a diagram illustrating a capacitive touch system according to an embodiment.

FIG. 4 is an exemplary diagram illustrating the detection circuit transmitting a first transmission signal to a first axis line of the plurality of first axis lines.

FIG. 5 is a diagram illustrating a delay between the first transmission signal and any first detection signal of the plurality of first detection signals being not greater than the first predetermined value.

FIG. 6 is a diagram illustrating a delay between the first transmission signal and the first detection signal being greater than the first predetermined value.

FIG. 7 is a diagram illustrating the microprocessor controlling the detection circuit to transmit a second transmission signal to a second axis line.

FIG. 8 is a diagram illustrating the delay between the second transmission signal and the second detection signal being greater than the second predetermined value.

FIG. 9 is a flowchart illustrating a method of operating a capacitive touch system according to another embodiment.

### DETAILED DESCRIPTION

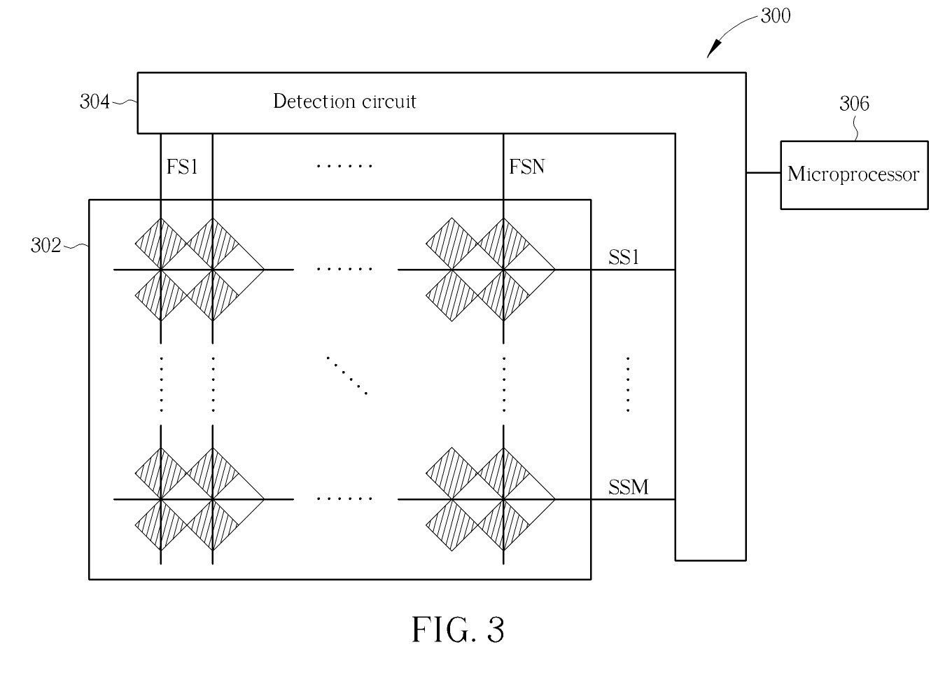

Please refer to FIG. 3. FIG. 3 is a diagram illustrating a capacitive touch system 300 according to an embodiment. The capacitive touch system 300 includes a touch panel 302, a detection circuit 304, and a microprocessor 306. The touch panel 302 includes a plurality of first axis lines FS1-FSN of a first axis and a plurality of second axis lines SS1-SSM of a second axis, where N and M are integers, and the first axis and the second axis are perpendicular to each other. In addition, the touch panel 302 can be a projected capacitive touch panel, and also be a mutual capacitance touch panel. The detection circuit 304 is coupled to the touch panel 302. The microprocessor 306 is used for controlling the detection circuit 304 to transmit a first transmission signal to each first axis line of the plurality of first axis lines FS1-FSN, and receive a plurality of first detection signals corresponding to each first transmission signal from the plurality of second axis lines SS1-SSM. If a delay between a first detection signal of a plurality of first detection signals corresponding to a first transmission signal and the first transmission signal is greater than a first predetermined value, the microprocessor 306 controls the detection circuit 304 to transmit a second transmission signal to a second axis line corresponding to the first detection signal, and receives a plurality of second detection signals corresponding to the second transmission signal from the plurality of first axis lines FS1-FSN.

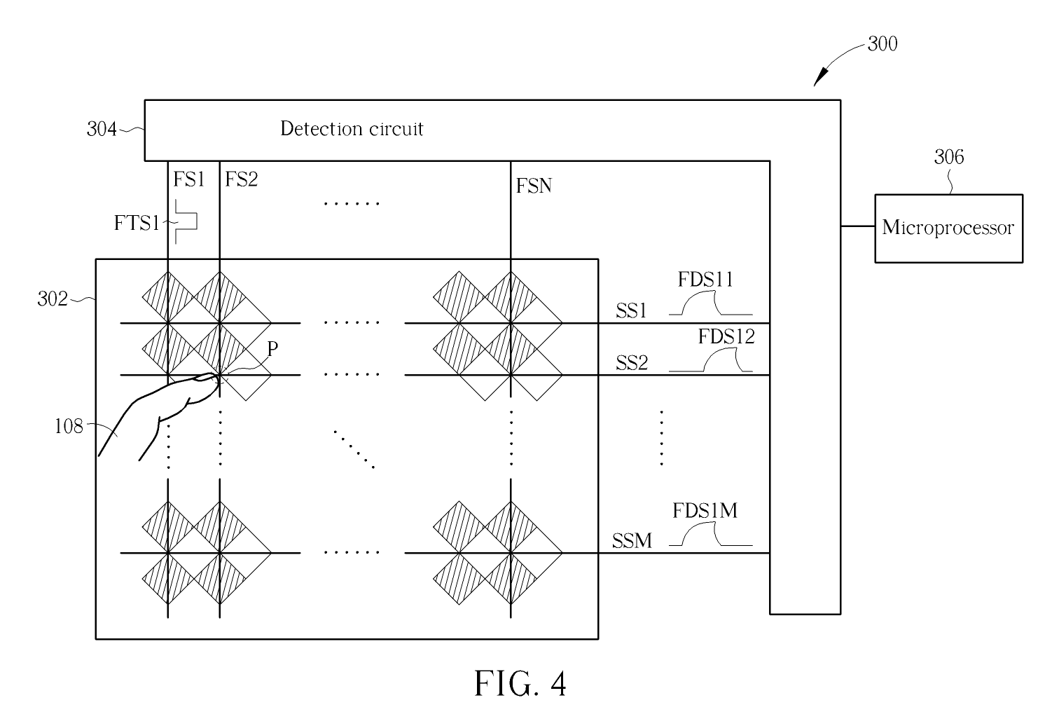

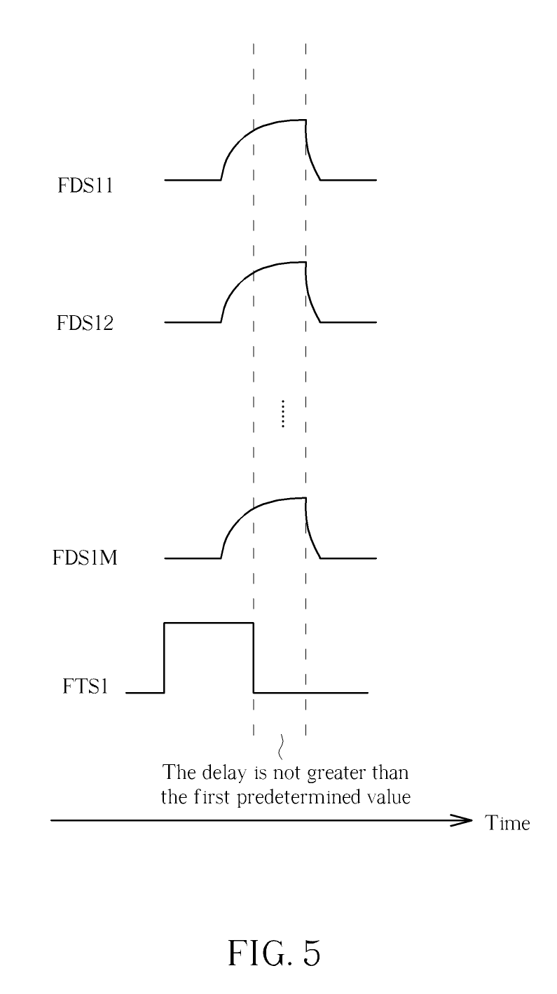

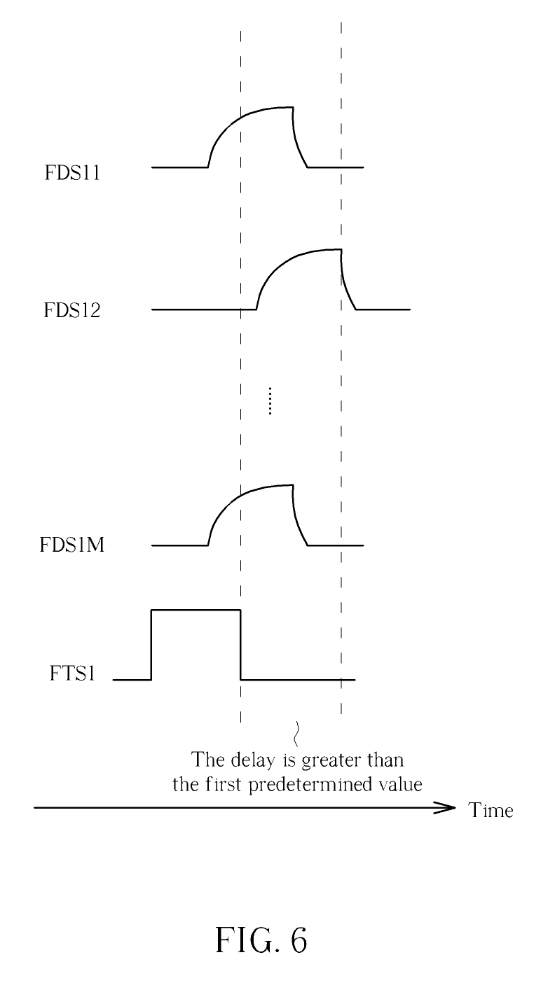

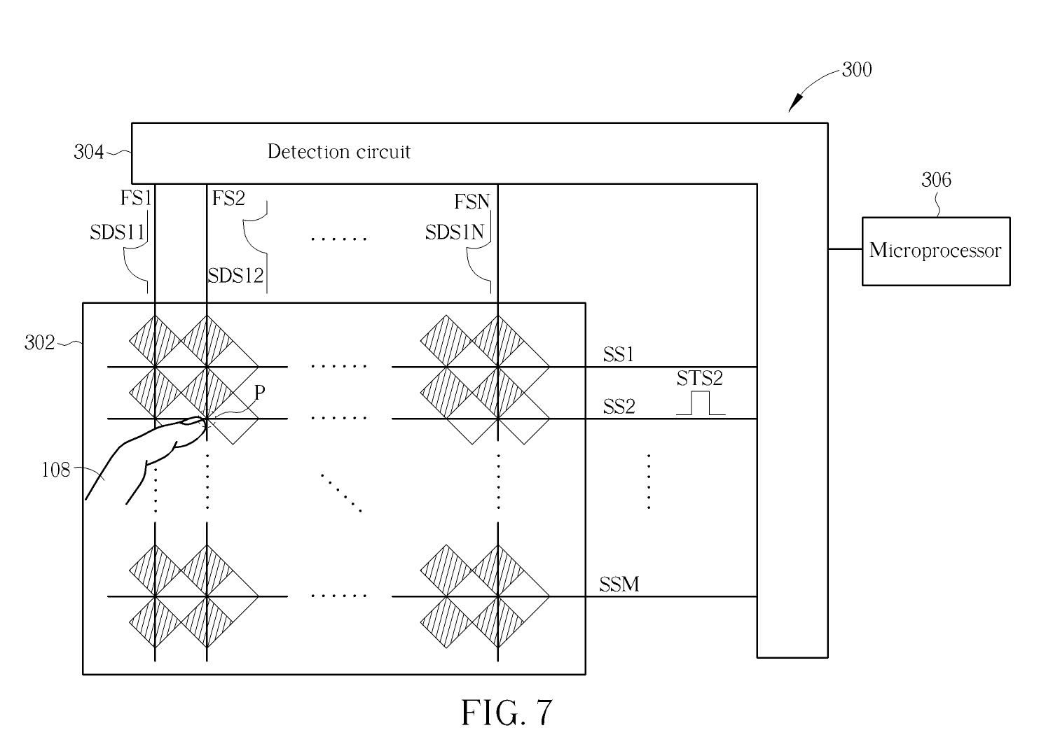

Please refer to FIG. 4, FIG. 5, FIG. 6, and FIG. 7. FIG. 4 is an exemplary diagram illustrating the detection circuit 304 transmitting a first transmission signal FTS1 to a first axis line FS1 of the plurality of first axis lines FS1-FSN, FIG. 5 is a diagram illustrating a delay between the first transmission signal FTS1 and any first detection signal of the plurality of first detection signals FDS11-FDS1M being not greater than the first predetermined value, FIG. 6 is a diagram illustrating a delay between the first transmission signal FTS1 and the first detection signal FDS12 being greater than the first predetermined value, and FIG. 7 is a diagram illustrating the microprocessor 306 controlling the detection circuit 304 to transmit a second transmission signal STS2 to a second axis line SS2. As shown in FIG. 4, when the microprocessor 306 controls the detection circuit 304 to transmit the first transmission signal FTS1 to the first axis line FS1 (meanwhile, the first axis line FS1 acts as a transmitting signal line of the detection circuit 304), the microprocessor 306 can control the detection circuit 304 to receive a plurality of first detection signals FDS11-FDS1M corresponding to the first transmission signal FTS1 from the plurality of second axis lines SS1-SSM (meanwhile, the plurality of second axis lines SS1-SSM act as receiving signal lines of the detection circuit 304). As shown in FIG. 5, if when a delay between the first transmission signal FTS1 and any first detection signal of the plurality of first detection signal FDS11-FDS1M is not greater than the first predetermined value, the microprocessor 306 controls the detection circuit 304 to transmit a first transmission signal (FTS2) to a first axis line FS2 next to the first axis line FS1, and the microprocessor 306 controls the detection circuit 304 to receive a plurality of second detection signals corresponding to the first transmission signal (FTS2) from the plurality of second axis lines SS1-SSM. As shown in FIG. 6 and FIG. 7, because when a finger 108 touches a touch point P of the touch panel 302, a parasitic capacitor of the finger 108 is parallel to a parasitic capacitor adjacent to the touch point P of the touch panel 302, resulting in a capacitance of the parasitic capacitor adjacent to the touch point P of the touch panel 302 being increased. Because the capacitance of the parasitic capacitor adjacent to the touch point P of the touch panel 302 is increased, when a delay (as shown in FIG. 4) between the first transmission signal FTS1 and a first detection signal FDS12 of the plurality of first detection signals FDS11-FDS1M is greater than the first predetermined value, the microprocessor 306 controls the detection circuit 304 to transmit the second transmission signal STS2 to the second axis line SS2 (meanwhile, the second axis line SS2 acts as a transmitting signal line of the detection circuit 304) corresponding to the first detection signal FDS12, and the microprocessor 306 controls the detection circuit 304 to receive a plurality of second detection signals SDS11-SDS1N corresponding to the second transmission signal STS2 from the plurality of first axis lines FS1-FSN (meanwhile, the plurality of first axis lines FS1-FSN act as receiving signal lines of the detection circuit 304). Because the capacitance of the parasitic capacitor adjacent to the touch point P of the touch panel 302 is increased, a delay between the second transmission signal STS2 and a second detection signal SDS12 of the plurality of second detection signals SDS11-SDS1N is greater than a second predetermined value (as shown in FIG. 7). Thus, the microprocessor 306 can calculate a location of the touch point P of the touch panel 302 according to the first detection signal FDS12 and the second detection signal SDS12. That is to say, because the second axis line SS2 is changed from a receiving signal line of the detection circuit 304 to a transmitting signal line of the detection circuit 304, the second axis line SS2 is not interfered by noise from the touch panel 302 easily.

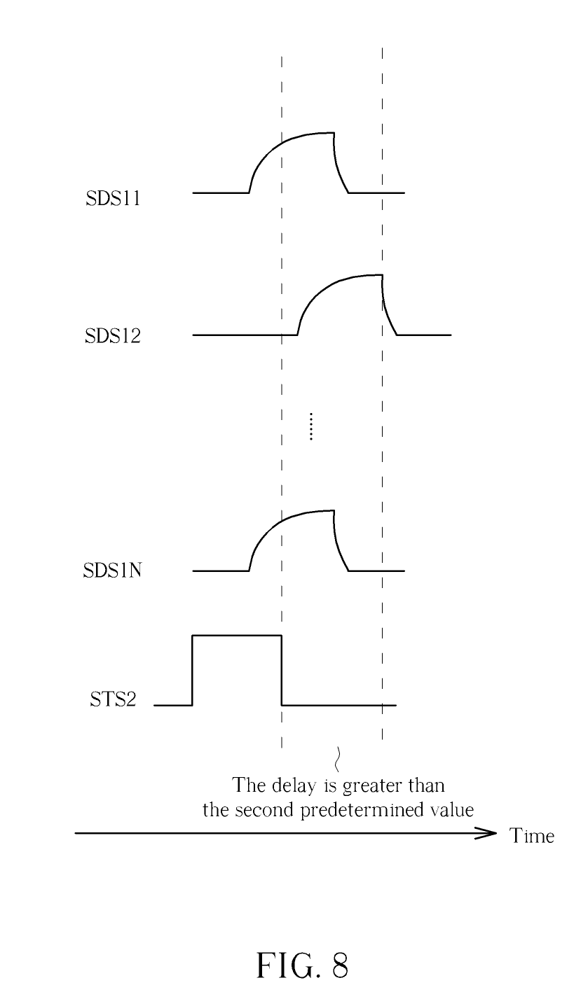

Please refer to FIG. 8. FIG. 8 is a diagram illustrating the delay between the second transmission signal STS2 and the second detection signal SDS12 being greater than the second predetermined value. As shown in FIG. 7 and FIG. 8, because the delay between the second transmission signal STS2 and the second detection signal SDS12 is greater than the second predetermined value, the microprocessor 306 can calculate the location of the touch point P of the touch panel 302 according to the second detection signal SDS12. After the microprocessor 306 calculates the location of the touch point P, the microprocessor 306 can control the detection circuit 304 to transmit a first detection signal (FTS2) to the first axis line FS2 next to the first axis line FS1, and the microprocessor 306 can control the detection circuit 304 to receive a plurality of second detection signals corresponding to the first transmission signal (FTS2) from plurality of second axis lines SS1-SSM. In addition, subsequent operational principles of another first axis line FS2-FSN of the first axis are the same as those of the first axis line FS1, so further description thereof is omitted for simplicity.

In addition, in another embodiment of the present invention, the detection circuit 304 is integrated into the microprocessor 306.

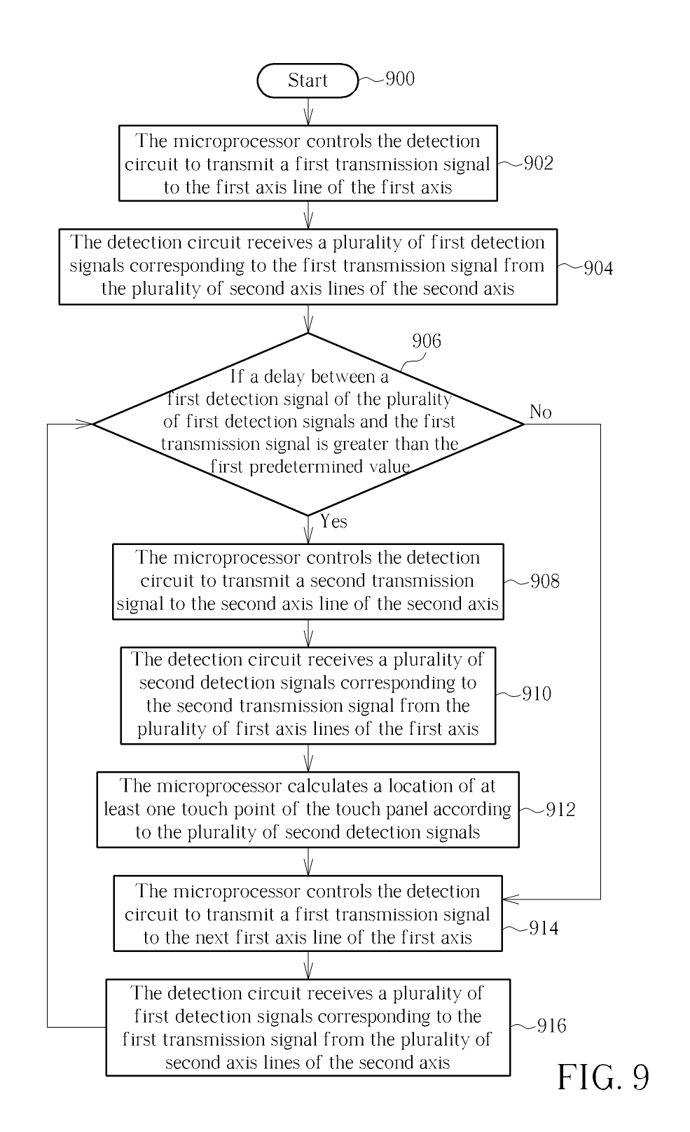

Please refer to FIG. 3, FIG. 4, FIG. 5, FIG. 6, FIG. 7, FIG. 8, and FIG. 9. FIG. 9 is a flowchart illustrating a method of operating a capacitive touch system according to another embodiment. The method in FIG. 9 is illustrated using the capacitive touch system 300 in FIG. 3. Detailed steps are as follows:

Step 900: Start.

Step 902: The microprocessor 306 controls the detection circuit 304 to transmit a first transmission signal FTS1 to the first axis line FS1 of the first axis.

Step 904: The detection circuit 304 receives a plurality of first detection signals FDS11-FDS1M corresponding to the first transmission signal FTS1 from the plurality of second axis lines SS1-SSM of the second axis.

Step 906: If a delay between a first detection signal of the plurality of first detection signals FDS11-FDS1M and the first transmission signal FTS1 is greater than the first predetermined value; if yes, go to Step 908; if no, go to Step 914.

Step 908: The microprocessor 306 controls the detection circuit 304 to transmit a second transmission signal STS2 to the second axis line SS2 of the second axis.

Step 910: The detection circuit 304 receives a plurality of second detection signals SDS11-SDS1N corresponding to the second transmission signal STS2 from the plurality of first axis lines FS1-FSN of the first axis.

Step 912: The microprocessor 306 calculates a location of at least one touch point of the touch panel 302 according to the plurality of second detection signals SDS11-SDS1N, go to Step 914.

Step 914: The microprocessor 306 controls the detection circuit 304 to transmit a first transmission signal (FTS2) to the next first axis line FS2 of the first axis.

Step 916: The detection circuit 304 receives a plurality of first detection signals corresponding to the first transmission signal (FTS2) from the plurality of second axis lines SS1-SSM of the second axis.

In Step 902 and Step 904, the first axis and the second axis are perpendicular to each other. In Step 904, as shown in FIG. 4, when the microprocessor 306 controls the detection circuit 304 to transmit the first transmission signal FTS1 to the first axis line FS1, the microprocessor 306 can control the detection circuit 304 to receive the plurality of first detection signals FDS11-FDS1M corresponding to the first transmission signal FTS1 from the plurality of second axis lines SS1-SSM. In Step 908, as shown in FIG. 6 and FIG. 7, when a delay between a first detection signal FDS12 of the plurality of first detection signals FDS11-FDS1M and the first transmission signal FTS1 is greater than the first predetermined value, the microprocessor 306 controls the detection circuit 304 to transmit the second transmission signal STS2 to the second axis line SS2 corresponding to the first detection signal FDS12. In Step 910, as shown in FIG. 7, the detection circuit 304 receives the plurality of second detection signals SDS11-SDS1N corresponding to the second transmission signal STS2 from the plurality of first axis lines FS1-FSN. In Step 912, because the detection circuit 304 transmits the second transmission signal STS2 to the second axis line SS2, the microprocessor 306 can calculate a location of at least one touch point of the touch panel 302 according to the plurality of second detection signals SDS11-SDS1N. That is to say, the second axis line SS2 is changed from a receiving signal line of the detection circuit 304 to a transmitting signal line of the detection circuit 304, so the second axis line SS2 is not interfered by noise from the touch panel 302 easily. Thus, as shown in FIG. 7 and FIG. 8, because the delay between the second transmission signal STS2 and the second detection signal SDS12 is greater than the second predetermined value, the microprocessor 306 can calculate a location of a touch point P of the touch panel 302 according to the second detection signal SDS12. In Step 914, after the microprocessor 306 calculates the location of the touch point P, the microprocessor 306 can control the detection circuit 304 to transmit the first detection signal (FTS2) to the first axis line FS2 next to the first axis line FS1, and the microprocessor 306 can control the detection circuit 304 to receive a plurality of second detection signals corresponding to the first transmission signal (FTS2) from the plurality of second axis lines SS1-SSM. In Step 916, after the detection circuit 304 receives the plurality of first detection signals corresponding to the first detection signal (FTS2), go to Step 906. Thus, the microprocessor 306 can continuously calculate a location of at least one touch point of the touch panel 302 through the above mentioned Steps. In addition, in Step 906, if when a delay between the first transmission signal FTS1 and any first detection signal of the plurality of first detection signal FDS11-FDS1M is not greater than the first predetermined value, go to Step 914. In addition, subsequent operational principles of another first axis line FS2-FSN of the first axis are the same as those of the first axis line FS1, so further description thereof is omitted for simplicity.

To sum up, the capacitive touch system and the method of operating the capacitive touch system first utilize the microprocessor to control the detection circuit to transmit a first transmission signal to a first axis line, and receive a plurality of first detection signals corresponding to the first transmission signal from the plurality of second axis lines. Then, when a delay between a first detection signal of the plurality of first detection signals and the first transmission signal is greater than the first predetermined value, the microprocessor controls the detection circuit to transmit a second transmission signal to a second axis line corresponding to the first detection signal. Then, the microprocessor controls the detection circuit to receive a plurality of second detection signals corresponding to the second transmission signal from the plurality of first axis lines. Thus, compared to the prior art, the present invention has advantages of quick scan and reducing interference of receiving signal lines of the detection circuit caused by an object which touches the touch panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A capacitive touch system, comprising:
a touch panel comprising a plurality of first axis lines of a first axis and a plurality of second axis lines of a second axis;
a detection circuit coupled to the touch panel; and
a microprocessor for controlling the detection circuit to transmit a first transmission signal to a first axis line, and receiving a plurality of first detection signals corresponding to the first transmission signal from the plurality of second axis lines, wherein if a delay between a first detection signal of the plurality of first detection signals and the first transmission signal is greater than a first predetermined value, the microprocessor controls the detection circuit to transmit a second transmission signal to a second axis line corresponding to the first detection signal, and receive a plurality of second detection signals corresponding to the second transmission signal from the plurality of first axis lines.

2. The capacitive touch system of claim 1, wherein the touch panel is a projected capacitive touch panel.

3. The capacitive touch system of claim 2, wherein the projected capacitive touch panel is a mutual capacitance touch panel.

4. The capacitive touch system of claim 1, wherein the detection circuit is integrated into the microprocessor.

5. The capacitive touch system of claim 1, wherein the first axis and the second axis are perpendicular to each other.

6. The capacitive touch system of claim 1, wherein the microprocessor is further used for calculating a location of at least one touch point of the touch panel according to the plurality of second detection signals.

7. A method of operating a capacitive touch system, the capacitive touch system comprising a touch panel, a detection circuit, and a microprocessor, wherein the touch panel comprises a plurality of first axis lines of a first axis and a plurality of second axis lines of a second axis, the method comprising:
the microprocessor controlling the detection circuit to transmit a first transmission signal to a first axis line, and receiving a plurality of first detection signals corresponding to the first transmission signal from the plurality of second axis lines;
the microprocessor controlling the detection circuit to transmit a second transmission signal to a second axis line corresponding to a first detection signal of the plurality of first detection signals, and receiving a plurality of second detection signals corresponding to the second transmission signal from the plurality of first axis lines if a delay between the first detection signal and the first transmission signal is greater than a first predetermined value; and
the microprocessor calculating a location of at least one touch point of the touch panel according to the plurality of second detection signals.

8. The method of claim 7, wherein the first axis and the second axis are perpendicular to each other.
